(19) United States
(12) Patent Application Publication
(10) Pub. No.: US 2018/0225307 A1
(43) Pub. Date: Aug. 9, 2018

(54) Two-stage, facial recognition and identification system (two-stage facial R & I system)

(71) Applicant: ROBERT WILLIAM KOCHER, MCLEAN, VA (US)

(72) Inventor: ROBERT WILLIAM KOCHER, MCLEAN, VA (US)

(21) Appl. No.: 15/330,258

(22) Filed: Aug. 31, 2016

(51) Int. Cl. G06F 17/30; G06K 9/00

(52) U.S. Cl. CPC G06F 17/30256; G06K 9/00288; G06F 17/30554; G06F 17/30274

(57) ABSTRACT

The Two-Stage Facial Recognition and Identification System allows law enforcement officers, military personnel, and other users the ability to rapidly identify wanted or known personnel and assist through a second stage of examiner and hardware to better confirm whether positive or negative identification has been made. This system will greatly reduce misidentification, profiling, or any other identification weaknesses that the mobile device user may have. The system allows the initial contact photograph to be matched on a mobile device, and if the mobile device user desires, the photograph can be sent back to a central server and subject matter expert. The subject matter expert in turn can send an image or audio message back to the mobile device user alerting them of any dangers, as well as providing a professional identification statement and any associated warnings or instruction.

### CROSS-REFERENCE TO RELATED APPLICATION

None

### FEDERALLY SPONSORED RESEARCH

None

### BACKGROUND PRIOR ART

This invention applies to the general field of biometrics, and more specifically, computer-performed facial recognition and human-performed facial identification.

There are several major challenges with the current state-of-the-art in facial recognition, facial identification, and the capacity of mobile devices to hold and rapidly search very large databases. The same applies to non-mobile servers. Servers can contain hundreds of millions of faces, but current face template size limits search potential such that conducting face recognition searches above 700 million images on a server is extremely technologically challenging, and searching over one half million on a standard mobile device such as a cell phone is unrealistic.

Facial recognition is defined in this application as a computer process that converts an image of a face into a template, then through a search algorithm and a template database, creates a match score against the templates in the database.

Facial identification is defined in this application as a human comparing two or more face images to determine if the images are a match, no-match, or there is insufficient information to make a determination.

In addition to the limited database size on mobile devices and search limitation with current state-of-the-art systems, there are two additional problems: (1) the identification burden falls on the mobile device user to determine if the photos are a match or no-match, and (2) lack of ability to rapidly search an additional larger database, one on the mobile device and if needed a deep dive search of a larger database on a server system.

As facial image databases grow on mobile devices, the probability of false matches grows and the match or no-match decision becomes more difficult. This problem is complicated because the photo taken by the user of the mobile device may not have pristine standards. If the mobile device expands from 20,000 images to 100,000 images on the device, there is a high probability of false matches from the watch will significantly increase. This would require current mobile device users such as law enforcement officers or soldiers to make an identification decision based on looking at a small screen. This problem can lead to many other problems such as inadvertent arrests and unintentional racial profiling, or even lives lost on the battlefield.

Current state-of-the-art fails with: (1) the ability to search large databases on a mobile device, (2) the ability to search very large databases (over a billion) in server systems, and (3) the ability of a facial identification examiner to offer rapid assistance to the person with the mobile device in making an identification decision.

### SUMMARY

The Two-Stage, Face Recognition and Identification System (Two-Stage Facial-R & I System) invention will allow rapid, mobile device-based, very large database searching (Stage One) with the ability to request a real time expert opinion and additional searching against extremely large databases (Stage Two). This new approach to facial recognition and identification in Stage One is based on new technology breakthroughs in image template sizes that allow searching and storage of millions of face photos on a mobile device such as a cell phone and billions on laptop server hardware. This system will allow federated searching on mobile devices and rapid results and decisions on easy match or no-match calls. Stage Two provides in-depth back-up support for Stage One, if needed, for a more in-depth electronic search with a more powerful computer, and the expert identification services personnel can review those computer-generated matches that fall into a grey area and the Stage One operator cannot make a clear match or no-match.

From a law enforcement perspective, the Two-Stage Facial Recognition and Identification System will quickly recognize felons, missing persons, or other sought after persons with a high degree of accuracy, thus preventing false identifications or rejections, which will result in significantly fewer persons being taken to the station due to mismatches.

### OBJECTS AND ADVANTAGES

The Two-Stage Facial Recognition and Identification System is a breakthrough in providing the law enforcement officer, solider or user in the presence of an individual the ability to search a massive database to see if the subject person is in the database. A key application would be in the law enforcement determining if a person is in the Wants & Warrants list. Wants are personnel that are wanted by the law enforcement community for questioning potentially missing persons, or persons of interest. Warrants are typically arrest warrants for wanted persons. Due to recent breakthroughs in technology of extremely small facial template sizes, this capability would allow mobile devices to contain database sizes that were never thought possible before. Should the operator with the Stage One mobile device need a second opinion, additional advice, or a deeper search into massive databases, the officer can simply transmit the image to the Stage Two system where an examiner can provide additional identification advice and search extremely powerful computing systems. This text message or phone call to the mobile device can provide real-time instructions, assessments, warnings and documentation (what to do with the individual). In the Wants category, law enforcement may just have a photograph of a suspect and this facial recognition identification would be extremely helpful at bringing in a person from the photograph. An example may be video from bank robberies, persons standing next to criminals, or personnel standing next to missing persons.

In addition to Wants & Warrants databases, other databases for military use such as identifying suspects where military has only photographs. Other databases for the military could be friendly in nature, such as determining if this person is a coalition member. Current technology relies on a person's uniform. Here countries could exchange valid images of their personnel for recognition and identification.

Additional databases for commercial use could be sports figures, politicians, actors—famous personnel that such a device could be used commercially for identifying personnel whose photos are normally found on the Internet.

Other databases could contain DMV databases that would assist in recognizing an individual in traffic accidents or medical emergencies. This device could be used by Emergency Medical Transport (EMT) or emergency room personnel in ident a person who is severely injured, incapacitated or unconscious to rapidly identify the individual with the purpose of getting the proper medical records and identification of next of kin. The Stage Two component of our system is vital in ensuring that we have the correct person. Medical organizations could have their own databases of patients to ensure the identity of personnel before offering medical services.

The system could also be used for rapidly identifying terrorists or wanted persons, or are time-sensitive wanted persons, by distributing the photograph to all mobile devices that contained matching software.

Another database would also be for customs and border personnel as a watchlist of who's coming in or documentation of who's entering or leaving the country.

### DESCRIPTION OF THE SEVERAL VIEWS OF THE DRAWINGS

FIG. 1 shows Stage One, the mobile device and its basic components.

FIG. 2 shows Stage One, the mobile device and software functioning.

FIG. 3 shows information flow between Stage One and Stage Two where only examination services are needed.

FIG. 4 shows information flow between Stage One and Stage Two whereby a larger database is searched and examination services are provided.

FIG. 5 shows information flow between Stage One and Stage Two whereby a larger database and other databases are searched and examination services are provided.

### LIST OF REFERENCE NUMERALS

1 mobile device
2 camera on mobile device
3 communications module on mobile device
4 gallery of stored face images and corresponding biographical data
5 search template database
6 matching algorithm and related software on mobile device
7 communication link to central server system
8 identity examiner's display
9 Stage Two central server database
10 integration software and matching algorithm on examiner's station
11 text, audio or image message created by identity examiner from central server to mobile device
12 communications network between central server and mobile device
13 software that captures incoming image and adds it to the server database
14 face recognition matches on the mobile device above threshold value
15 image taken by the mobile device camera or other source
17 other Stage Two databases that require separation (e.g. intelligence, law enforcement, commercial organization)
18 mobile device display
20 highest ranking face image above threshold on mobile device
21 template of face image 15
22 displayed matching score above threshold
23 central processor within the mobile device
24 software that converts image 15 to template
25 Stage Two corresponding template image highest threshold match
26 additional Stage Two matches

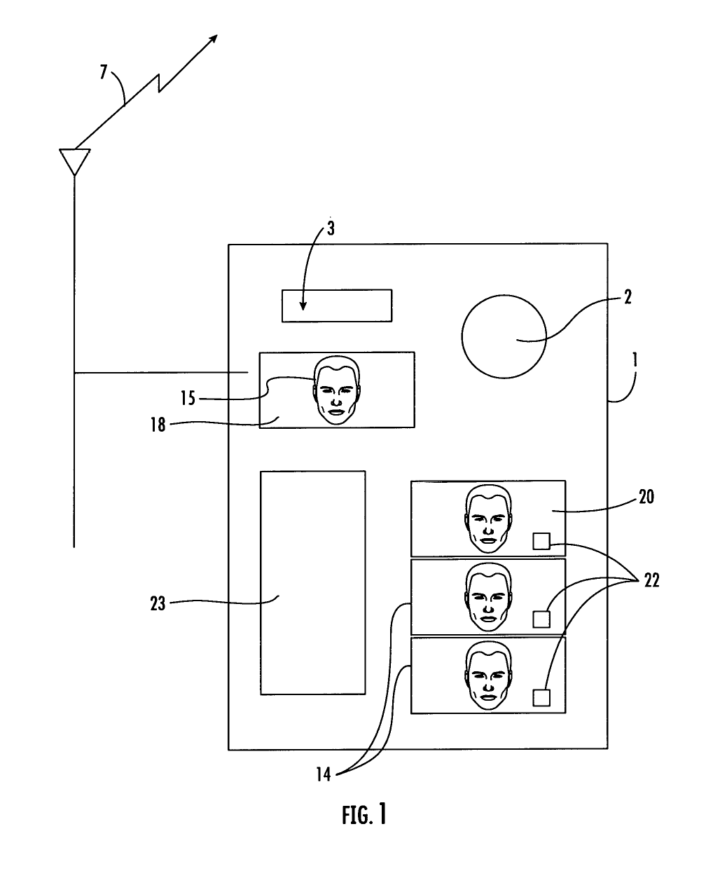

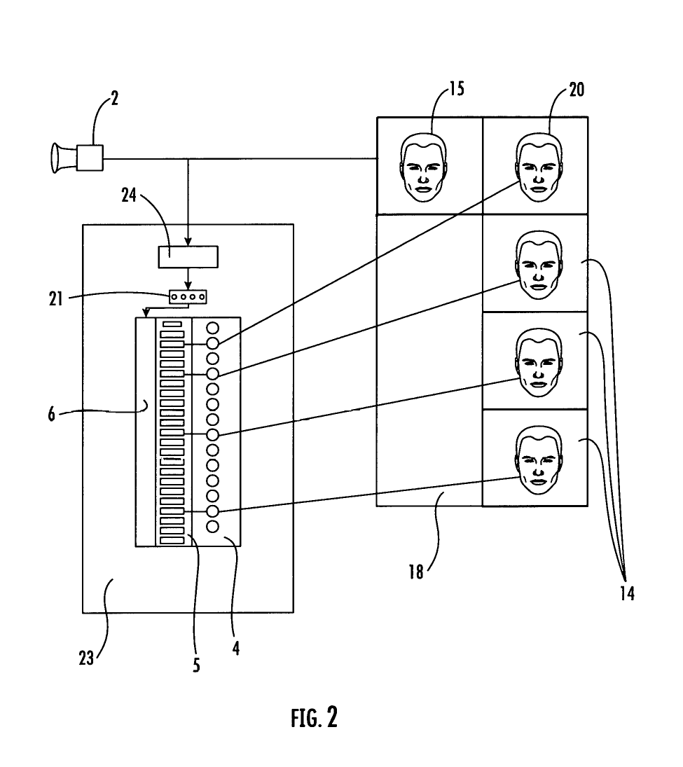

### DETAILED DESCRIPTION FIG. 1 AND FIG. 2 FIRST EMBODIMENT

The Two-Stage Facial Recognition and Identification System (Two-Stage Facial R & I System) has several operational options. One of the ways to ensure rapid response is to have a match result early in the recognition and identification process. This is basically Stage 1. Stage 1 occurs at the location where the person in question's photo is taken, recognition is done by the mobile device, and identification is performed by the person taking the photo. This decentralized approach greatly reduces data requirements because nothing has to be sent to a central location. This is significantly faster than waiting in a queue for results from another location.

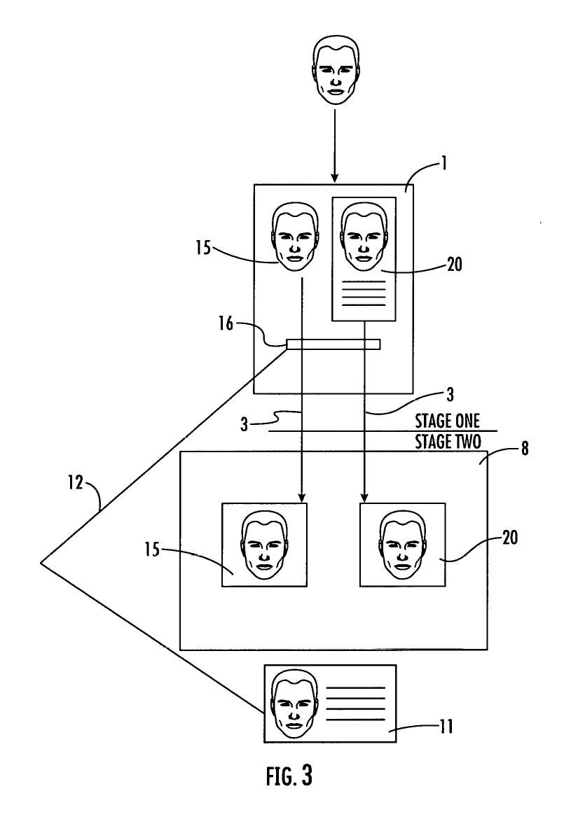

One embodiment of the Two-Stage Facial Recognition and Identification System is combining the system components in FIG. 1 and FIG. 2 in combination with FIG. 3. This combination provides a new synergistic approach by using the convenience and capabilities of numerous, standalone mobile devices operated by security personnel in conjunction with a powerful centrally located server operated by subject matter experts. This system provides the ability to the mobile device operator to send an assistance message concerning face identification and related biographical data on the matched person.

FIG. 1 (Embodiment 1) depicts the Stage One handheld device 1 containing a camera 2; a communications module 3; a display 18, which displays the face images 15 take with the camera 2; computer recognized face images 4; and the central processor 23.

FIG. 2 (Embodiment 1) depicts the Stage One handheld device 1 containing a camera 2 taking a photograph 15, which is converted via software 24 to a template 21. The template 21 is processed through an algorithmic search engine 6, whereby it is matched against a database of templates 5. Once a match is made against the template 5, it is associated with its corresponding facial photograph and biographical data 4. From this gallery 4, the highest ranking face image 20 is isolated and then rendered alongside the original photograph 15, as well as other potential matches 14, on a display 18. The rank score 22 can also be displayed next to each match 14.

### FIG. 3—Alternative Embodiments

FIG. 3 (Embodiment 2) depicts an operator who looks at the photograph 15 and wants an opinion from the Stage Two examiner. The operator transmits the captured image 15 and the match image 20 to the Stage Two examiner. The images are displayed on the examiner's display 8; the examiner compares the image taken 15 to the highest-ranked above threshold image 20 and determines the degree of identification. The examiner will then create and send a message 11 through the communications network 12 to the mobile device 1 for the Stage One operator's action. The message could contain the degree of identification, biographical data on the individual, a request to take another photograph, or an additional request for information (such as a scar mark or tattoo). The examiner's message could also contain cautionary information such as the individual is armed, dangerous, mentally afflicted or any other information that the operator should know.

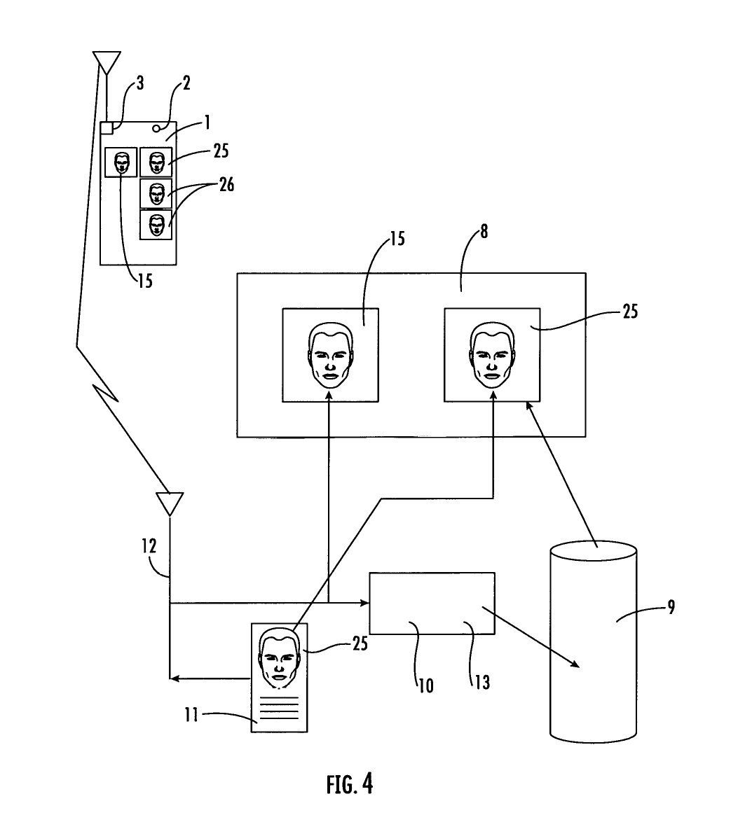

### FIG. 4—Alternative Embodiments

FIG. 4 (Embodiment 3) depicts a communications network 12 transmitting a facial photograph 15 taken via mobile device 1 on its camera 2 via its communications module 3. The photograph 15 is processed through the template conversion algorithm 10, and added to the database 9 via software module 13. As matches are made above threshold within database 9, it will display the image 25 and possibly multiple images 26 on the examiner's station 8 next to the original photograph 15. As the examiner determines the degree of identification, the examiner sends back a message 11, which may contain image 25 and images 26, to the operator of the mobile device 1. The text message would be displayed along with the image 25 and 26 on the mobile device 1. The message could contain the degree of identification, biographical data on the individual, a request to take another photograph, or an additional request for information (such as a scar mark or tattoo). The examiner's message could also contain cautionary information such as the individual is armed, dangerous, mentally afflicted or any other information that the operator should know.

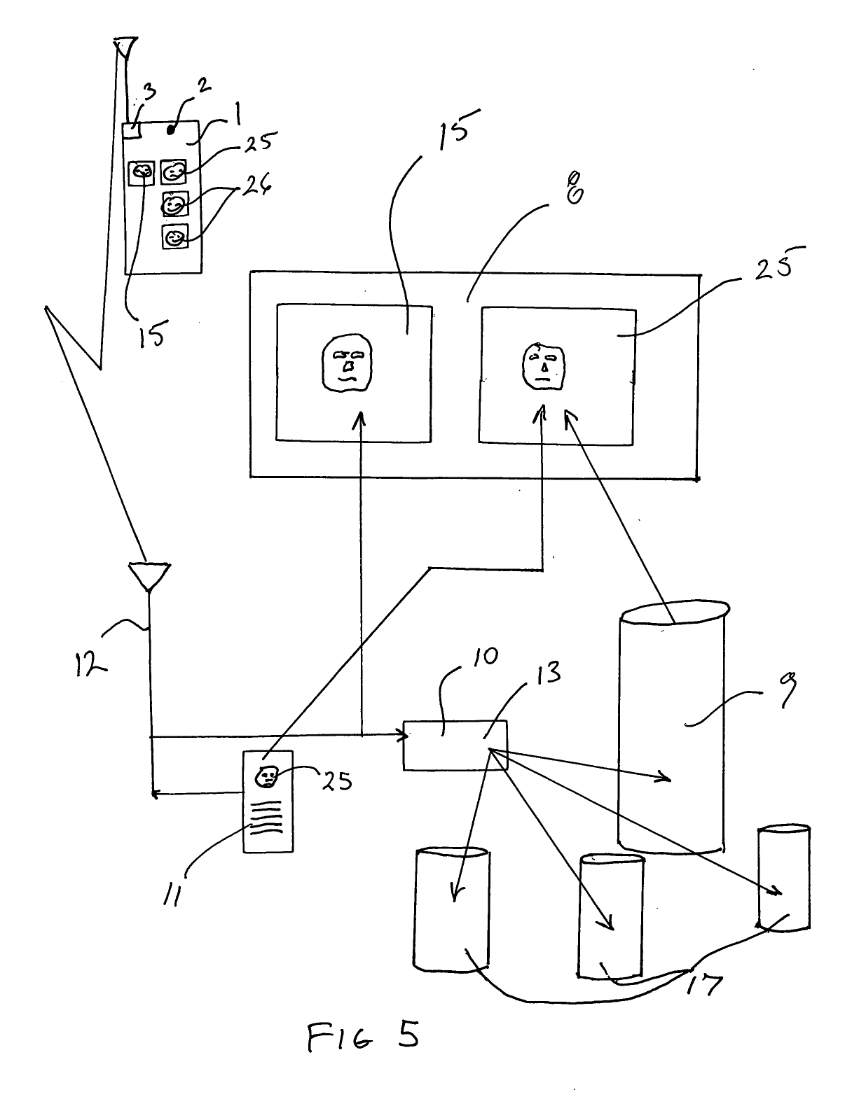

### FIG. 5—Alternative Embodiments

FIG. 5 (Embodiment 4) occurs when the Stage One operator does not receive a match, but would like to run the photo against Stage Two databases 17. In Embodiment 4 additional databases 17 are searched independently for matches. These independent databases can come from intelligence organizations, law enforcement, and private sources that do not allow the mixing of databases. A database could be classified which could not be mixed with another classified database. The results would be provided to the examiner and the examiner can take action in accordance with the data restriction. The examiner can then send back a message 11 with additional identification or information on how to handle the individual.

### CONCLUSION, RAMIFICATIONS, AND SCOPE

The Two-Stage Facial Recognition and Identification System will allow a more rapid and higher probability of match identification that has not existed to this date. This two-stage approach allows the Stage One user access to a subject matter expert for identification purposes. The two-stage process allows the easy matches to be resolved in the first stage without burdening the second stage. The two-stage process represents significant cost savings by focusing a subject matter expert's abilities to support multiple users of a mobile device, and also allows rapid communication of either text, image or audio with the mobile device. The Two-Stage Facial Recognition and Identification System allows separation of different classifications of databases for individual searches. The system will greatly enhance the ability to identify personnel who are wanted by law enforcement or who have issued warrants.

Although the description above contains many specificities, these should not be construed as limiting the scope of the embodiments but as merely providing illustrations of several of the embodiments. For example, the wide variety of databases in Stage One and Stage Two can structure multiple uses of the system to identify strangers or identify authorized personnel.

Thus the scope of the embodiments should be determined by the appended claims and their legal equivalents, rather than by the examples given.

1. A method for facial recognition and facial identification of personnel from very large databases comprising:
a. providing standalone, face recognition search of a select database on a mobile device,
b. providing a means for photographing an individual and converting the photograph into a biometric template,
c. providing a search algorithm that will compare said biometric template in said database and determine a facial recognition match score,
d. providing a means for displaying the results of said recognition search on said mobile device,
e. providing a capability to transmit said photograph or additional photographs to a central server location,
f. receiving said photographs from said mobile device and displaying said photographs on video screens in a manner that allows a professional facial matching examiner to conduct facial identification of said photos, and,
g. transmitting from said central server images, audio, or text messages back to said mobile device providing guidance on the results of said examination of photos.

2. The method of claim 1 wherein an additional facial recognition search is performed by servers at the central server location utilizing larger databases than those found on the mobile device.

3. A facial recognition and facial identification system, comprising:
a. a mobile device comprising:
a. a camera, capable of taking a face image,
b. software to convert the said face image into a template,
c. a database consisting of photographic images and templates,
d. a face matching algorithm,
e. a video display capable of displaying the said face image against the results of the said face matching algorithm,
f. a communications system capable of connecting with a central server,
b. a central server with software capable of receiving communications from said mobile device,
c. a video display capable of displaying said face images transmitted by the mobile device,
d. software that can convert said face image from said mobile device into a template,
e. software algorithm that can search said template with a very large database, and,
f. software that enables text, video, or audio messages to be sent between said central server to said mobile device.

4. The system of claim 3 wherein video images from the server can be transmitted to the mobile device.

5. A means for rapidly identifying unknown persons by searching very large databases and providing near real-time results to the user comprising:
1. a mobile device providing a means for:
a. taking a photograph of an individual to be identified,
b. converting said photograph into a template,
c. searching the database on the said mobile device,
d. displaying the said photograph of an individual to be identified along with the closest match photographs in said database.
2. a central server providing an additional search capability if desired, and;
3. said central server providing a display for search results providing the means for a facial examiner to determine if the displayed data is a match, no-match or that there is insufficient data to make a decision.
